(19) United States
(12) Patent Application Publication
(10) Pub. No.: US 2009/0113336 A1
(43) Pub. Date: Apr. 30, 2009

(54) Device user interface including multi-region interaction surface

(76) Inventor: Eli Reifman, Ra'anana (IL)

Correspondence Address: Naomi Assia Law Offices;C/O Landon IP Inc., Suite 450, 1700 Diagonal Road, Alexandria, VA, 22314, US

(21) Appl. No.: 11/860,597

(22) Filed: Sep. 25, 2007

(51) Int. Cl. G06F 3/00

(52) U.S. Cl. 715/781

(57) ABSTRACT

According to some embodiments of the present invention there is provided a method, circuit and system for interfacing with an electronic device such as a mobile communication or computing device. According to some embodiments of the present invention, an electronic device is provided with a display having an active region/area and at least a first queue area. In response to a signal produced by: (1) a human input sensor, (2) sensor device, and/or (3) sensor array, items (e.g. icons representing applications or other data structures such a metadata) presented or displayed in the first queue area may be moved into the active region/area, while an item in the active region/area may be moved to a second queue area

### FIELD OF THE INVENTION

The present invention relates generally to the field of interfacing with an electronic device such as a mobile communication or computing device. More specifically, the present invention relates to a method, circuit and system for managing a set of items/icons displayed on a screen.

### BACKGROUND

A computer using a graphical user interface presents menus with a combination of text and symbols to represent choices. By clicking on one of the symbols, the operator is selecting the instruction that the symbol represents. A context menu is a menu in which the choices presented to the operator are automatically modified according to the current context in which the operator is working.

A common use of menus is to provide convenient access to various operations such as saving or opening a file, quitting a program, or manipulating data. Most widget toolkits provide some form of pull-down or pop-up menu. Pull-down menus are the type commonly used in menu bars (usually near the top of a window or screen), which are most often used for performing actions, whereas pop-up menus are more likely to be used for setting a value, and might appear anywhere in a window.

There is a need in the field of computing for an improved method of a interfacing with an electronic device using a graphical user interface.

### SUMMARY OF THE INVENTION

The present invention is a method, circuit and system for interfacing with an electronic device such as a mobile communication or computing device. According to some embodiments of the present invention, an electronic device is provided a display having an active region/area and at least a first queue area. In response to a signal produced by: (1) a human input sensor, (2) sensor device, and/or (3) sensor array, items (e.g. icons representing applications or other data structures such a metadata) presented or displayed in the first queue area may be moved into the active region/area, while an item in the active region/area may be moved to a second queue area.

According to some embodiments of the present invention, the display, including all areas may concurrently present a first set of items including application and data structure icons, whereas a first subset of the first set of items, including the majority of items in the first set, may reside (i.e. be present) within the first and/or the second queue areas(s). The active area/regions may display a second subset of items from the first set of items, which second subset may include one or more items and may be smaller than the first subset of items. Items may be moved from the first subset to the second subset in response to a signal from the human input sensor, thereby also moving the item from a queue area (i.e. first and/or second queue area) to the active area.

According to some embodiments of the present invention, an item (e.g. icon) may have one or more associated functions. According to further embodiments of the present invention, user interaction with the one or more functions associated with an item/icon may be restricted to items/icons residing (i.e. presented/displayed) within the active area of the display. A user may move an item/icon from a first queue area to the active area, or to a second queue area, by interacting with the sensor. Items in one of the queue areas may be moved: (1) to the active area, or (2) into another queue area in a sequence substantially corresponding to their position in the queue, such that the relative order between items is preserved.

According to further embodiments of the present invention, an electronic device may include control logic or other computing element(s) adapted to run an interface application adapted to facilitate the above described functionality. The sensor and a display driver and/or circuit may be functionally associated with the control logic or computing element(s). The control logic and/or elements may be discrete or may be part of a processor integral with the electronic device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram of an exemplary electronic device and/or mobile device with its display showing a set of items/icons, and wherein there is a first subset of items displayed in queue areas and a second subset of items displayed in an active area;

FIG. 2 is a block diagram of an exemplary electronic device and/or communication device according to some embodiments of the present invention, wherein a controller adapted to define on a display an active area and at least one queue area;

FIG. 3 is a flow chart depicting the steps of an embodiment of the present invention which may be executed by a controller adapted to define on a display an active area and at least one queue area;

FIGS. 4A and 4B are flow charts depicting the steps of an embodiment of the present invention which may be executed by a controller adapted to define on a display an active area and at least one queue area;

FIG. 5 is a diagram of an exemplary electronic device with its display showing a set of items/icons, and wherein the set of icons is arranged/moved based on a signal received from a human input sensor;

FIG. 6 shows an exemplary arrangement of items/icons on a display, and wherein icons move from (1) a first queue area to an active area, (2) from a second queue area to a first queue area and (3) from an active area to a second queue area based on a signal received from a human input sensor;

FIG. 7 is a diagram of an exemplary electronic device with its display showing a set of items/icons, and wherein the set of icons is arranged based on a signal received from a human input sensor; and

FIG. 8 shows an exemplary arrangement of items/icons on a display, and wherein icons move from (1) a second queue area to an active area, (2) from a first queue area to a second queue area and (3) from an active area to a first queue area based on a signal received from a human input sensor.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a method, circuit and system for interfacing with an electronic device such as a mobile communication or computing device. According to some embodiments of the present invention, an electronic device is provided a display having an active region/area and at least a first queue area. In response to a signal produced by: (1) a human input sensor, (2) sensor device, and/or (3) sensor array, items (e.g. icons representing applications or other data structures such a metadata) presented or displayed in the first queue area may be moved into the active region/area, while an item in the active region/area may be moved to a second queue area.

According to some embodiments of the present invention, the display, including all areas may concurrently present a first set of items including application and data structure icons, whereas a first subset of the first set of items, including the majority of items in the first set, may reside (i.e. be present) within the first and/or the second queue areas(s). The active area/regions may display a second subset of items from the first set of items, which second subset may include one or more items and may be smaller than the first subset of items. Items may be moved from the first subset to the second subset in response to a signal from the human input sensor, thereby also moving the item from a queue area (i.e. first and/or second queue area) to the active area.

According to some embodiments of the present invention, an item (e.g. icon) may have one or more associated functions. According to further embodiments of the present invention, user interaction with the one or more functions associated with an item/icon may be restricted to items/icons residing (i.e. presented/displayed) within the active area of the display. A user may move an item/icon from a first queue area to the active area, or to a second queue area, by interacting with the sensor. Items in one of the queue areas may be moved: (1) to the active area or (2) into another queue area in a sequence substantially corresponding to their position in the queue, such that the relative order between items is preserved.

According to further embodiments of the present invention, an electronic device may include control logic or other computing element(s) adapted to run an interface application adapted to facilitate the above described functionality. The sensor and a display driver and/or circuit may be functionally associated with the control logic or computing element(s). The control logic and/or elements may be discrete or may be part of a processor integral with the electronic device.

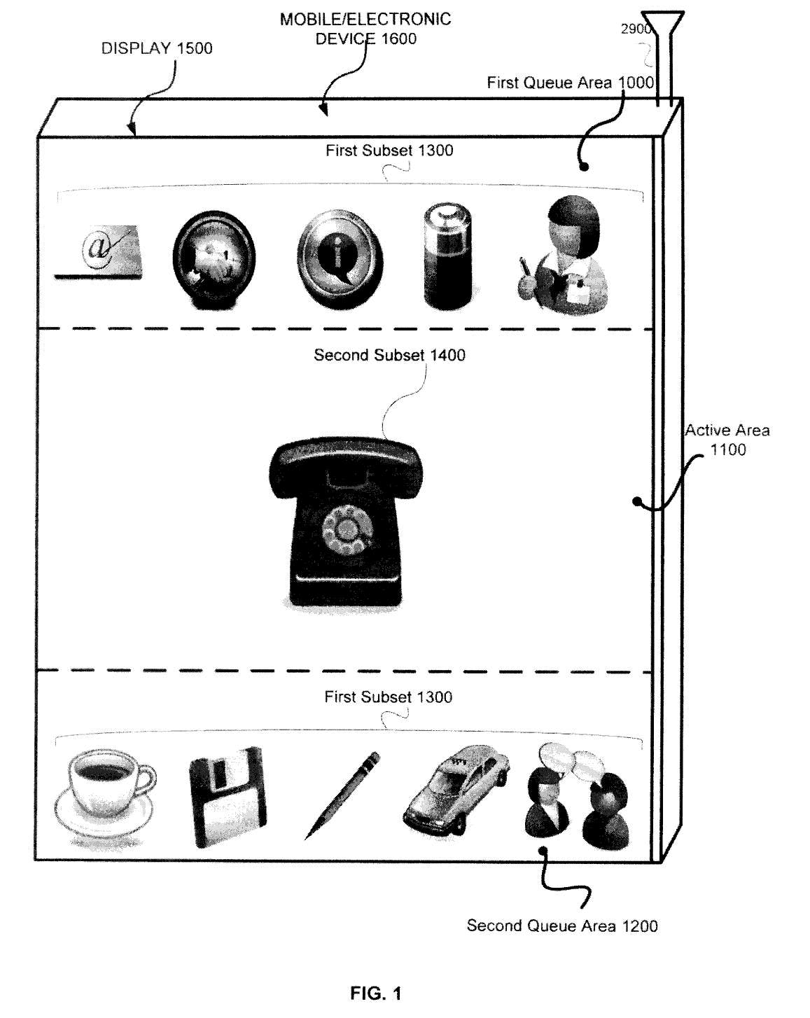

Turning now to FIG. 1, there is shown a diagram of an exemplary electronic device and/or mobile device 1600 with its display 1500 showing a set of items/icons, and wherein there is a first subset of items 1300 displayed in queue areas (1000 and 1200) and a second subset of items 1400 displayed in an active area 1100.

According to some embodiments of the present invention, the display 1500, including all areas may concurrently present a first set of items including application and data structure icons, whereas a first subset 1300 of the first set of items, including the majority of items in the first set, may reside (i.e. be present) within the first and/or the second queue areas(s) 1000 and 1200. The active area/region 1100 may display a second subset 1400 of items from the first set of items, which second subset may include one or more items and may be smaller than the first subset of items.

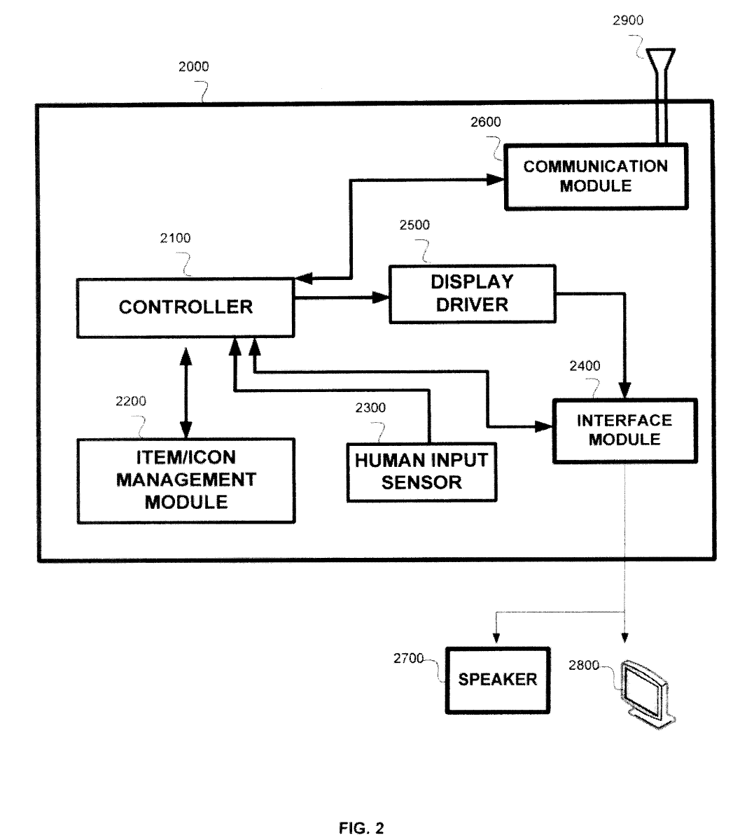

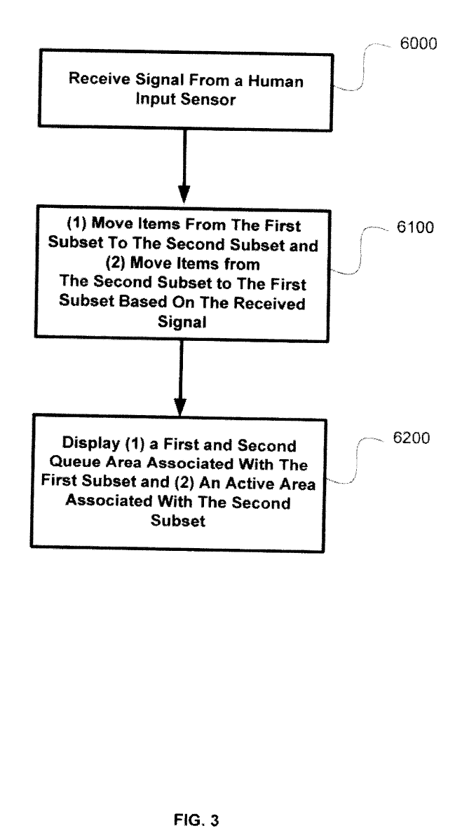

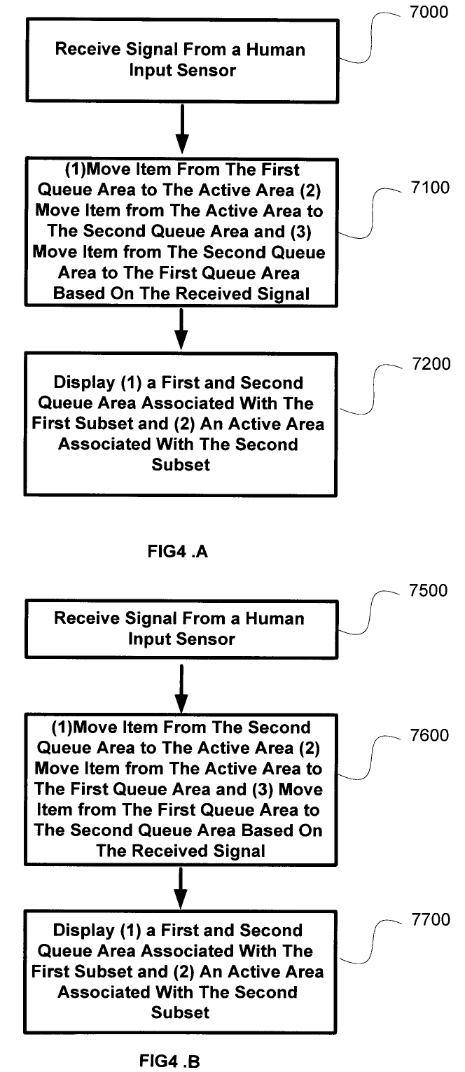

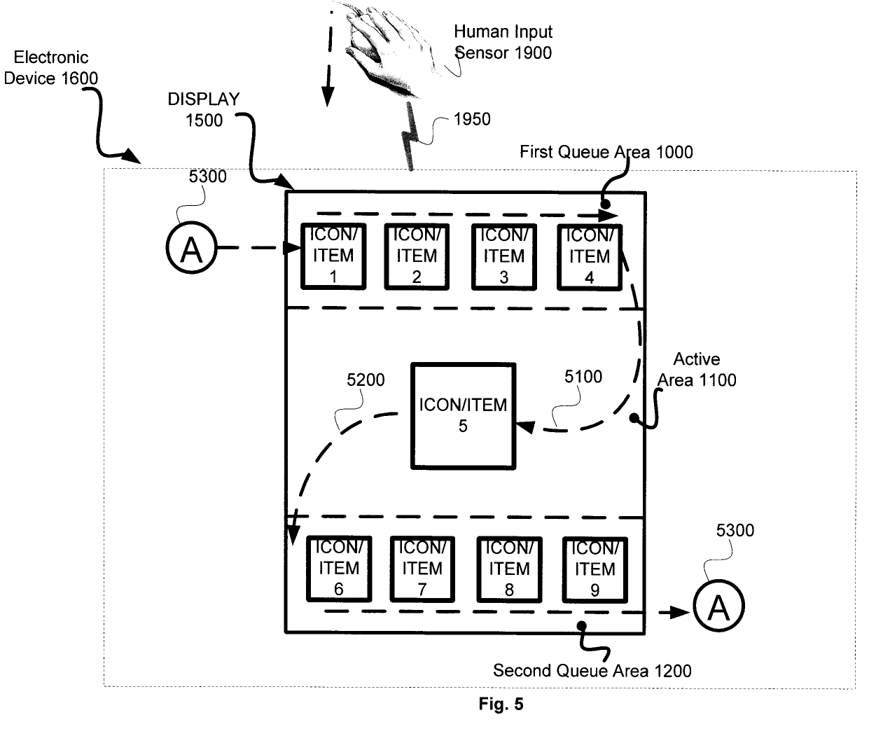

Turning now to FIG. 2, there is shown a block diagram of an exemplary electronic device and/or communication device 2000 according to some embodiments of the present invention, wherein a controller adapted to define on a display an active area and at least one queue area. According to some embodiments of the present invention, the electronic device may consist of : (1) a controller 2100, (2)an item/icon management module 2200, (3) a human input sensor 2300, (4) an interface module 2400, (5) a display driver 2500, (6) a communication module 2600 and (7) an antenna 2900. The functionality of the block diagram shown in FIG. 2 may best be described in conjunction with the flow charts depicted in FIGS. 3 and 4, and may be further explained in conjunction with FIGS. 5, 6, 7 and 8. According to some embodiments of the present invention, an electronic device as shown in FIGS. 1 and 2 is provided a display 2800 having an active region/area 1100 and at least a first queue area 1000. In response to a signal produced by: (1) a human input sensor 2300, (2) sensor device, and/or (3) sensor array, items (e.g. icons representing applications or other data structures such a metadata) presented or displayed in the first queue area may be moved into the active region/area 1100, while an item in the active region/area may be moved to a second queue area.

According to some embodiments of the present invention, a human input sensor may be any device adapted to receive a command from a user and translate it to a machine command (e.g. computer mouse, touch screen, keyboard, trackball etc.).

Turning now to FIG. 3, there is shown a flow chart depicting the steps of an embodiment of the present invention which may be executed by a controller 2100 adapted to present on a display 2800 using a display driver 2500 an active area 1100 and at least one queue area 1000 and 1200. According to some embodiments of the present invention, a controller 2100 is adapted to receive a signal from a human input sensor 2300 (step 6000).

According to some embodiments of the present invention, an item/icon management module 2200 may be adapted to (1) move items from the first subset 1300 to the Second Subset 1400 and (2) move items from the second subset 1400 to the first subset 1300 based on the received signal (step 6100).

According to some embodiments of the present invention, a controller 2100 is adapted to present on a display 2800 (1) a first and second queue area (1000 and 1200) associated with the first subset 1300 and (2) an active area 1100 associated with the second subset 1400 (step 6200). A detailed example and explanation of the functionality of steps 6100 and 6200 is given herein below in respect to FIGS. 5, 6, 7 and 8.

Turning now to FIG. 4A, there is shown a flow chart depicting the steps of an embodiment of the present invention which may be executed by a controller 2100 adapted to define on a display 2800 an active area 1400 and at least one queue area(1000 ad 1200). According to some embodiments of the present invention, a controller 2100 is adapted to receive a signal from a human input sensor 2300 (step 7000).

According to some embodiments of the present invention, a controller 2100 may be adapted to (1) move one or more items from the first queue area 1000 to the active area 1100 (2) move one or more items from the active area 1100 to the second queue area 1200 and (3) move item from the second queue area to the first queue area based on the received signal (step 7100).

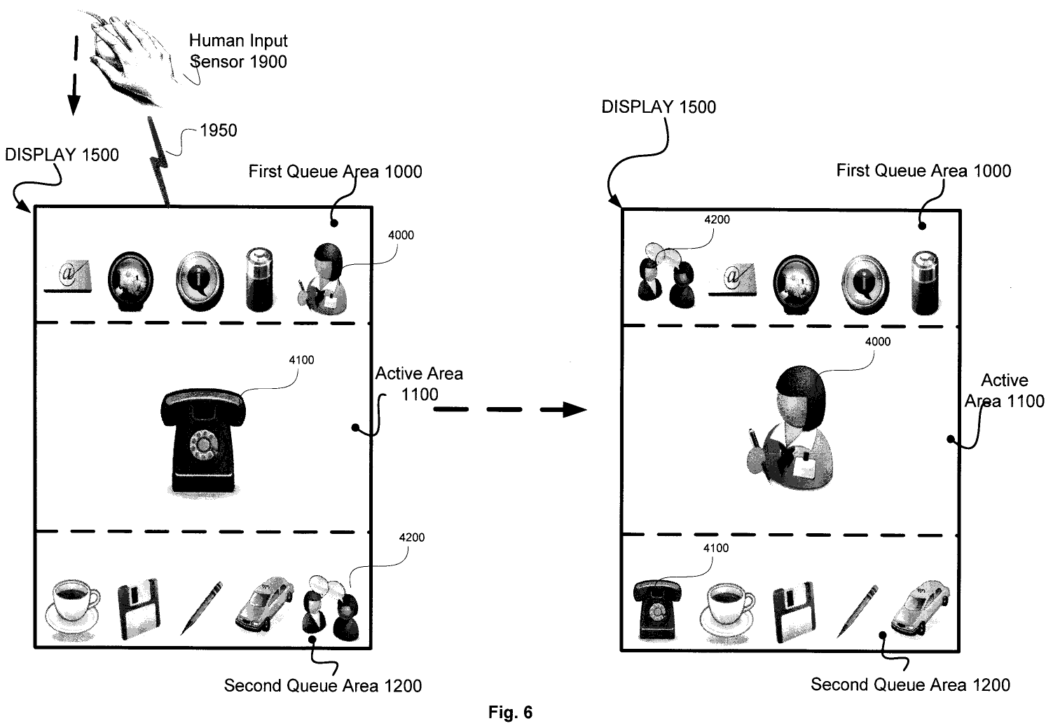

According to some embodiments of the present invention, a controller 2100 may be adapted to display (1) a first and second queue area (1000 and 1200) associated with the first subset 1300 and (2) an active area 1100 associated with the second subset 1400 (step 7200). A detailed example and explanation of the functionality of steps 7100 and 7200 is given herein below in respect to FIGS. 5 and 6.

Turning now to FIG. 4B, there is shown a flow chart depicting the steps of an embodiment of the present invention which may be executed by a controller 2100 adapted to define on a display 2800 an active area 1400 and at least one queue area(1000 ad 1200). According to some embodiments of the present invention, a controller 2100 may be adapted to receive a signal from a human input sensor 2300 (step 7300).

According to some embodiments of the present invention, a controller 2100 may be adapted to (1) move one or more items from the second queue area 1200 to the active area 1100 (2) move one or more items from the active area 1100 to the first queue area 1000 and (3) move item from the first queue area to the second queue area based on the received signal (step 7600).

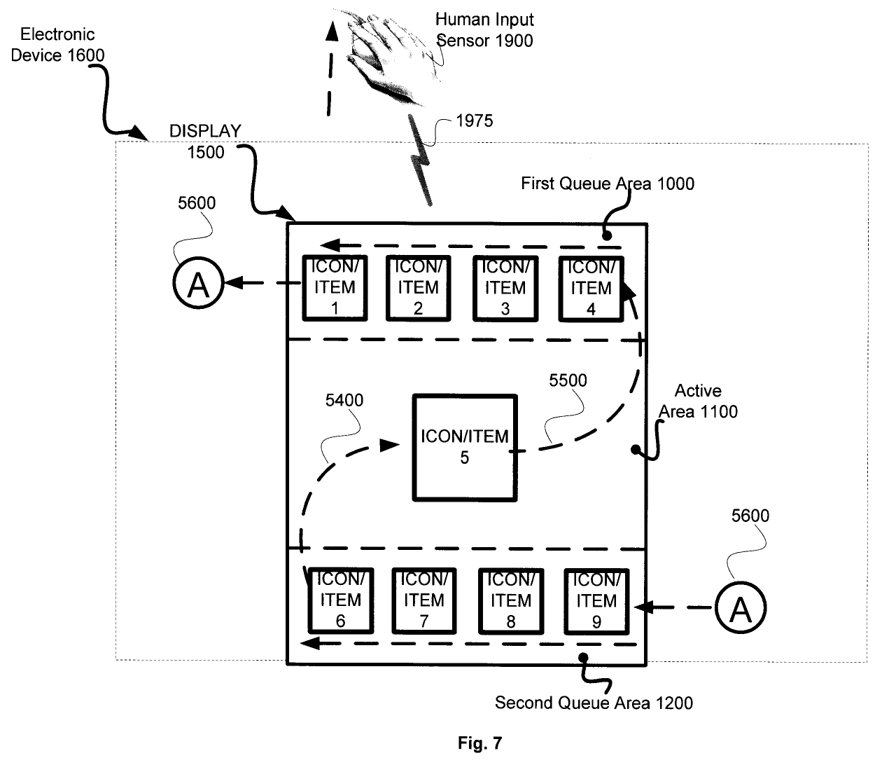

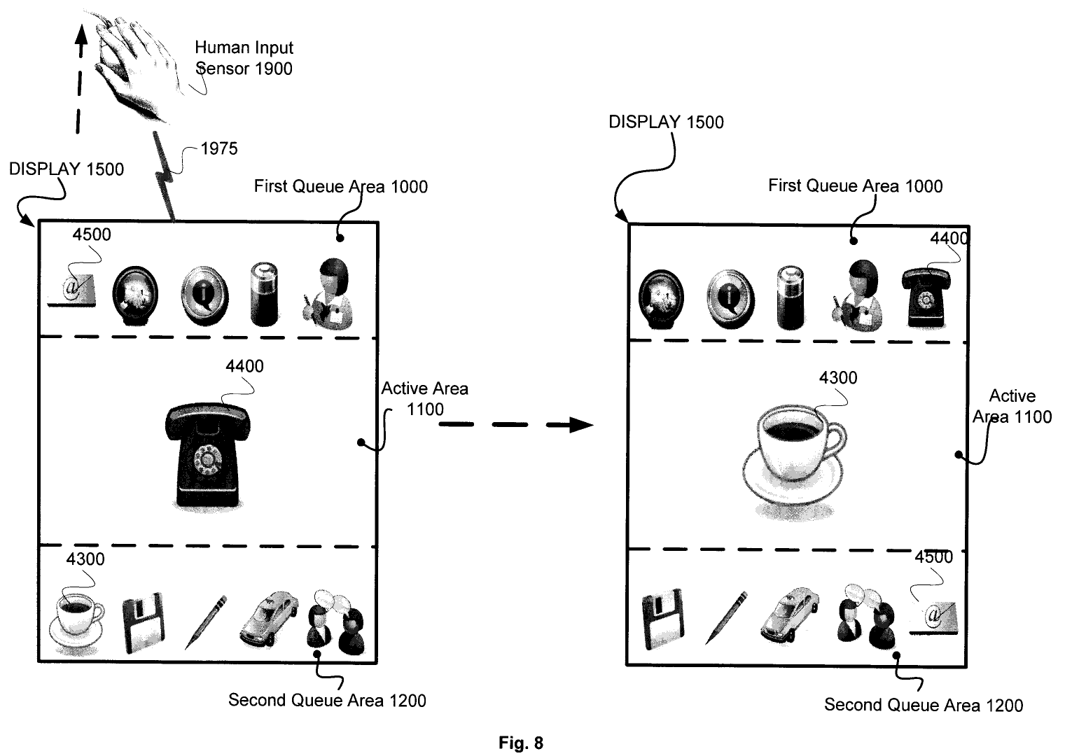

According to some embodiments of the present invention, a controller 2100 may be adapted to display (1) a first and second queue area (1000 and 1200) associated with the first subset 1300 and (2) an active area 1100 associated with the second subset 1400 (step 7700). A detailed example and explanation of the functionality of steps 7600 and 7700 is given herein below in respect to FIGS. 7 and 8.

Turning now to FIG. 5, there is shown a diagram of an exemplary electronic device 1600 with its display 1500 showing a set of items/icons, and wherein the set of icons is arranged/moved based on a signal 1950 received from a human input sensor 1900. More specifically, FIG. 5 shows (1) motion of the items/icons in the queue areas and (2) motion from one active/queue area to another active/queue area, which motions are presented using dotted arrows. FIG. 5 is functionally associated with FIG. 6, there is shown an exemplary arrangement of items/icons on a display, and wherein icons move from (1) a first queue area 1000 to an active area 1100, (2) from a second queue area 1200 to a first queue area 1000 and (3) from an active area 1100 to a second queue area 1200 based on a signal 1950 received from a human input sensor 1900. FIGS. 5 and 6 correspond with the steps of FIG. 4A.

According to some embodiments of the present invention, a human input sensor 1900 may send a signal 1950 (“down signal”) to an electronic device 1600, which electronic device may include a controller 2100. According to some embodiments of the present invention, a controller may be adapted to (1) move one or more items 4000 from the first queue area to the active area (motion 5100) (2) move one or more items 4100 from the active area to the second queue area (motion 5200) and (3) move one or more items 4200 from the second queue area to the first queue area (motion 5300) based on the received signal 1950 (step 7100).

Turning now to FIG. 7, there is shown a diagram of an exemplary electronic device 1500 with its display 1600 showing a set of items/icons, and wherein the set of icons is arranged/moved based on a signal 1975 received from a human input sensor 1900. More specifically, FIG. 7 shows (1) motion of the items/icons in the queue areas and (2) motion from one active/queue area to another active/queue area, which motions are presented using dotted arrows. FIG. 7 is functionally associated with FIG. 8, there is shown an exemplary arrangement of items/icons on a display, and wherein icons move from (1) a second queue area 1200 to an active area 1100, (2) from a first queue area 1000 to a second queue area 1200 and (3) from an active area 1100 to a first queue area 1000 based on a signal 1975 received from a human input sensor 1900. FIGS. 7 and 8 correspond with the steps of FIG. 4B.

According to some embodiments of the present invention, a human input sensor 1900 may send a signal 1975 (“up signal”) to an electronic device 1600, which electronic device may include a controller 2100. According to some embodiments of the present invention, a controller may be adapted to (1) move one or more items 4300 from the second queue area to the active area (motion 5400) (2) move one or more items 4400 from the active area to the first queue area (motion 5500) and (3) move one or more items 4500 from the first queue area to the second queue area (motion 5600) based on the received signal 1975 (step 7600).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. An electronic device comprising:
a controller adapted to define on a display an active area and at least one queue area.

2. The device according to claim 1, further comprising a user input sensor.

3. The device according to claim 2, wherein said controller is adapted to present on the display a first set of items of items including application and data structure icons, whereas a first subset of the first set of items, including the majority of items in the first set, may reside (i.e. be present) within the first and/or the second queue areas.

4. The device according to claim 2, wherein said controller is adapted to present on the display an active area/regions associated with a second subset of items from the first set of items.

5. The device according to claim 2, wherein said controller is adapted to move items from the first subset to the second subset.

6. The device according to claim 2, wherein said controller is adapted to move items from the second subset to the first subset.

7. The device according to claims 5 and 6, wherein said movement is performed in response to a signal from the human input sensor
